(19) United States
(12) Patent Application Publication
(10) Pub. No.: US 2020/0159431 A1
(43) Pub. Date: May 21, 2020

(54) SENDING DEDUPLICATED DATA AND REHYDRATING AGENT

(71) Applicant: Hewlett Packard Enterprise Development LP, HOUSTON, TX (US)

(72) Inventors: Neil Andrew Fleming, Erskine (GB); Alastair Siater, Bristol (GB)

(21) Appl. No.: 16/092,403

(22) PCT Filed: Apr. 11, 2016
(86) PCT No.: PCT/US2016/026914

§ 371 Date: Oct. 9, 2018

(51) Int. Cl. G06F 3/06; G06F 11/14

(52) U.S. Cl. CPC G06F 3/0641; G06F 11/1453; G06F 2201/84; G06F 3/0608; G06F 3/0673; G06F 11/1469

(57) ABSTRACT

In some examples, a rehydrating agent is generated. In some examples, a consistent-in-time data set of deduplicated data is generated and the consistent-in-time data set and an executable copy of the rehydrating agent is sent to a storage resource.

### BACKGROUND

A computer system may generate a large amount of data. Loss of such data may be detrimental to an entity using the computer system. To protect from such loss, a data backup system may store at least a portion of the computer system's data. If a failure of the computer system prevents retrieval of some portion of the data, it may be possible to retrieve the data from the data backup system.

### BRIEF DESCRIPTION OF THE DRAWINGS

The following detailed description references the drawings, wherein:

FIG. 1 is a block diagram of a computing device to send a consistent-in-time data set of deduplicated data and an executable copy of a rehydrating agent to a storage resource, according to some examples.

FIG. 2A is a diagram of a consistent-in-time data set of deduplicated data sent coupled to an executable copy of a rehydrating agent, according to some examples.

FIG. 2B is a diagram of a consistent-in-time data set of deduplicated data sent separately from an executable copy of a rehydrating agent, according to some examples.

FIG. 2C is a diagram of a consistent-in-time data set of deduplicated data sent coupled to an executable copy of a rehydrating agent to multiple storage resources, according to some examples.

FIG. 2D is a diagram of a consistent-in-time data set of deduplicated data sent separately from an executable copy of a rehydrating agent to multiple storage resources, according to some examples.

FIG. 3 is a block diagram of a system to send a consistent-in-time data set of deduplicated data and an executable copy of a rehydrating agent, according to some examples.

FIG. 4 is a flowchart of a method of sending consistent-in-time data set of deduplicated data and a rehydrating agent to a remote storage resource, according to some examples.

FIG. 5A is a flowchart of an example method of sending consistent-in-time data set of deduplicated data and an executable copy of a rehydrating agent to a physical tape, including sending the consistent-in-time data set and the executable copy separately.

FIG. 5B is a flowchart of an example method of sending consistent-in-time data set of deduplicated data and an executable copy of a rehydrating agent to a physical tape, including sending the consistent-in-time data set and the executable copy together.

FIG. 5C is a flowchart of an example method of sending consistent-in-time data set of deduplicated data and an executable copy of a rehydrating agent to an object-based repository, including sending the consistent-in-time data set and the executable copy separately.

FIG. 5D is a flowchart of an example method of sending consistent-in-time data set of deduplicated data and an executable copy of a rehydrating agent to an object-based repository, including sending the consistent-in-time data set and the executable copy together.

FIG. 6 is a flowchart of an example method of restoring a consistent-in-time data set of deduplicated data using an executable copy of a rehydrating agent, according to some examples.

### DETAILED DESCRIPTION

A data backup system may use several techniques to ensure data protection. One such technique is data deduplication, a technique that divides a sequence of input backup data into an ordered collection of non-overlapping chunks of data. In the deduplication process, when a duplicate of original data is found, a pointer can be established to the original data, rather than storing another copy (i.e. a duplicate) of the original data. By storing unique chunks of data, deduplication enables backup data to be stored compactly and cheaply by decreasing needed storage space.

A data backup system may also store backup data in a location that is remote to the data generation site (e.g. data from a storage client), requiring a transfer of the data using established communication protocols. For example, deduplicated data may be stored in disk arrays that emulate a tape library (known as a virtual tape library (VTL)). Because deduplicated data is more compact than the input backup data, the transfer time of deduplicated data may be less than the transfer time of the input backup data. Thus, deduplication may also decrease bandwidth demands.

When deduplicated data is stored, it is stored in a manner that allows the data to easily interface with the method that created the deduplicated data (for example, a deduplication appliance or software). This is because deduplicated data is dependent on the mechanism that created it (i.e. the data is format opaque). For example, in some situations, a restore of deduplicated data needs to be done with the same appliance and same version of the appliance that created the deduplicated data. Thus, storing the deduplicated data in a manner that links it to the original deduplication method allows the deduplicated data to be rehydrated (or restored) back to its original duplicated form when needed using the original deduplication method.

This generates an issue for data backup systems because data backup systems, in addition to storing deduplicated data, may also safeguard data that has already been deduplicated. For example, storage resources such as physical tape (e.g. Linear Tape-Open (LTO), etc.) or object-based repositories operated over networks (e.g. S3, SWIFT, etc.) may be used for archiving purposes and long-term storage of the information held in deduplicated data. This provides a tertiary level of protection in addition to the secondary level of protection provided by the deduplicated data. In some situations, archiving data to physical tapes may be used to help comply with government or industry regulations.

Storage resources used for archiving purposes, however, are not linked to the deduplication method that created the deduplicated data. Without the deduplication method, it is difficult to rehydrate the deduplicated data and extract information from the deduplicated data. This is an issue in archiving the deduplicated data in its deduplicated form because data held in archives may not be needed for long periods of time after the archive date and it may be difficult to ensure that the deduplication method that created the deduplicated data will be accessible or available at the time of restoration from an archive.

Thus, often times, to archive deduplicated data in a useful form, the deduplicated data is rehydrated before it is sent to the storage resource. But this rehydration process is time consuming. Additionally, storing the data in its original, duplicated form burdens the data backup system's bandwidth and storage space.

Examples described herein address these issues by providing a way to store both deduplicated data and a mechanism to rehydrate the deduplicated data. In some examples, a consistent-in-time data set of deduplicated data is generated and a rehydrating agent is generated. The consistent-in-time data set and an executable copy of the rehydrating agent are then sent to the storage resource for storage.

In some examples, a computing device is provided with a processor, instructions to generate a rehydrating agent, instructions to generate a consistent-in-time data set of deduplicated data, and instructions to send the consistent-in-time data set and an executable copy of the rehydrating agent to a storage resource. The instructions are executable by the processor.

In some examples, a system is provided with a deduplication engine, a policy engine, a data generation engine, an agent generation engine, and a transmit engine. The deduplication engine generates deduplicated data. The policy engine determines an occurrence of a trigger event. In response to the occurrence of the trigger event, the data generation engine generates a consistent-in-time data set of the deduplicated data. The agent generation engine, in response to the occurrence of the trigger event, generates an executable copy of a rehydrating agent. The transmit engine then sends the consistent-in-time data set and an executable copy of the rehydrating agent to a storage resource.

In some examples, a method is provided to generate a consistent-in-time data set of deduplicated data and generate a rehydrating agent. The method includes sending the consistent-in-time data set and an executable copy of the rehydrating agent to a storage resource that is remote from the deduplicated data.

Thus, examples described herein allow for deduplicated data to be stored for archival purposes without dependence on the original method that generated the deduplicated data. This frees up the data backup system's storage space and bandwidth resources, allowing the data backup system to use deduplicated data in tertiary levels of data protection.

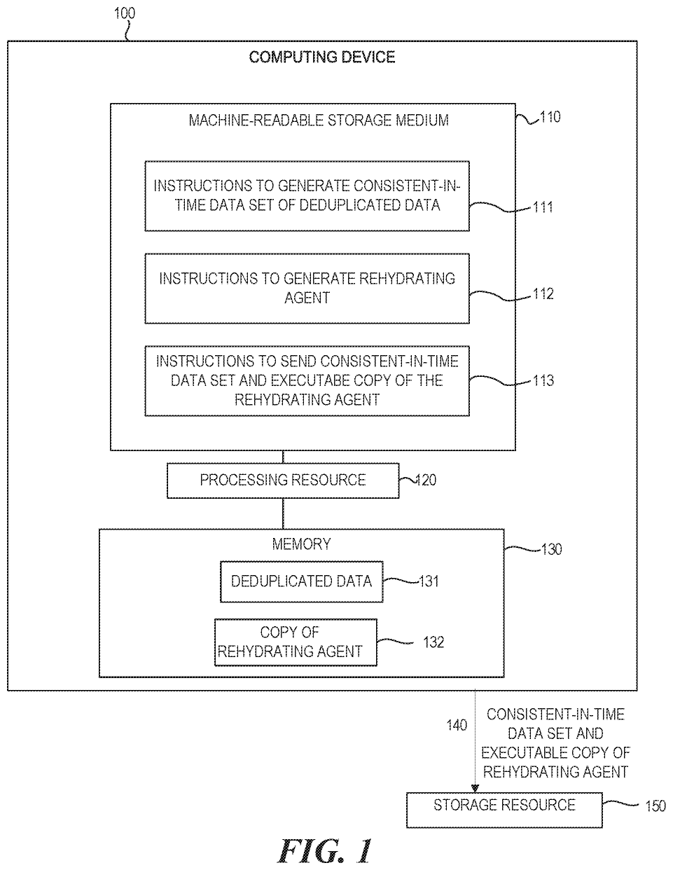

Referring now to the figures, FIG. 1 is a block diagram of an example computing device 100 to send deduplicated data and an executable copy of a rehydrating agent to a storage resource 150. As used herein, a “computing device” may be a server, computer networking device, chip set, desktop computer, workstation, or any other processing device or equipment. In some examples, computing device 100 may be a storage server that interfaces with a remote storage client.

Computing device 100 of FIG. 1 includes processing resource 120 and a storage medium 110. Storage medium 110 may be in the form of non-transitory machine-readable medium, such as suitable electronic, magnetic, optical, or other physical storage apparatus to contain or store information such as instructions 111, 112, and 113, related data, and the like.

As used herein, “machine-readable storage medium” may include a storage drive (e.g., a hard drive), flash memory, Random Access Memory (RAM), any type of storage disc (e.g., a Compact Disc Read Only Memory (CD-ROM), any other type of compact disc, a DVD, etc.) and the like, or combination thereof. In some examples, a storage medium can correspond to a memory including a main memory, such as a Random Access Memory (RAM), where software may reside during runtime, and a secondary memory. The secondary memory can, for example, include a nonvolatile memory where a copy of software or other data, such as deduplicated data, is stored.

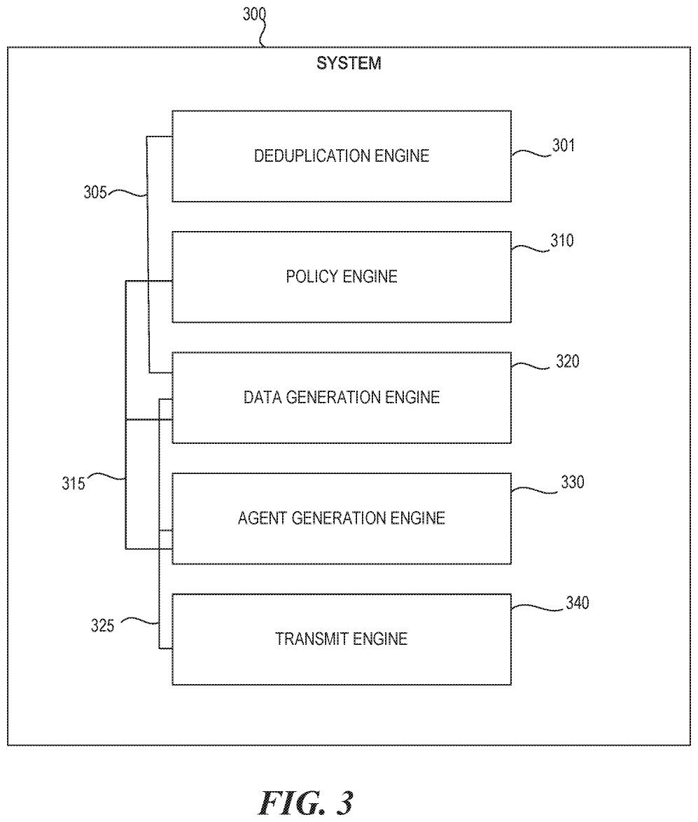

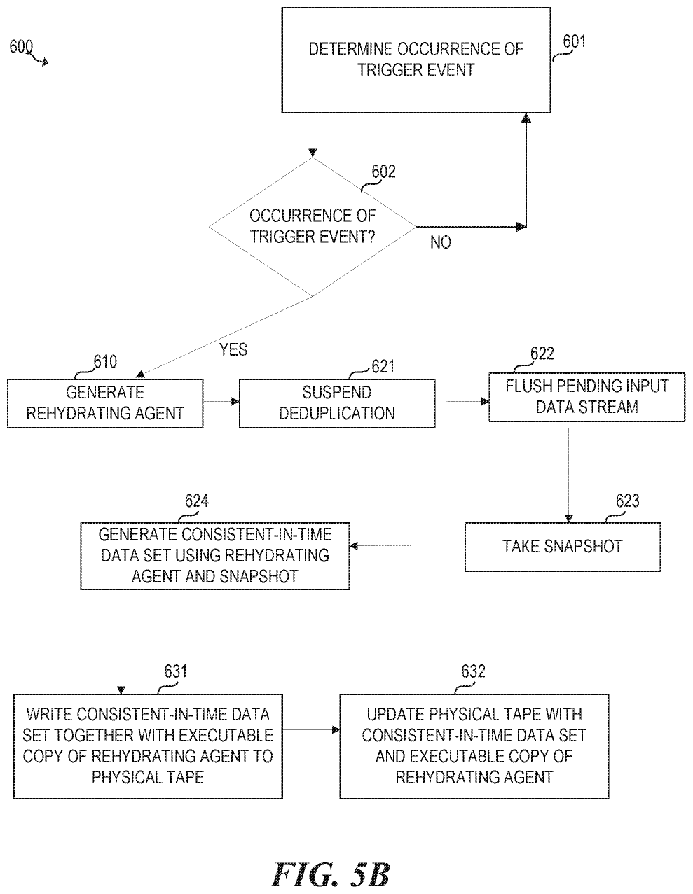

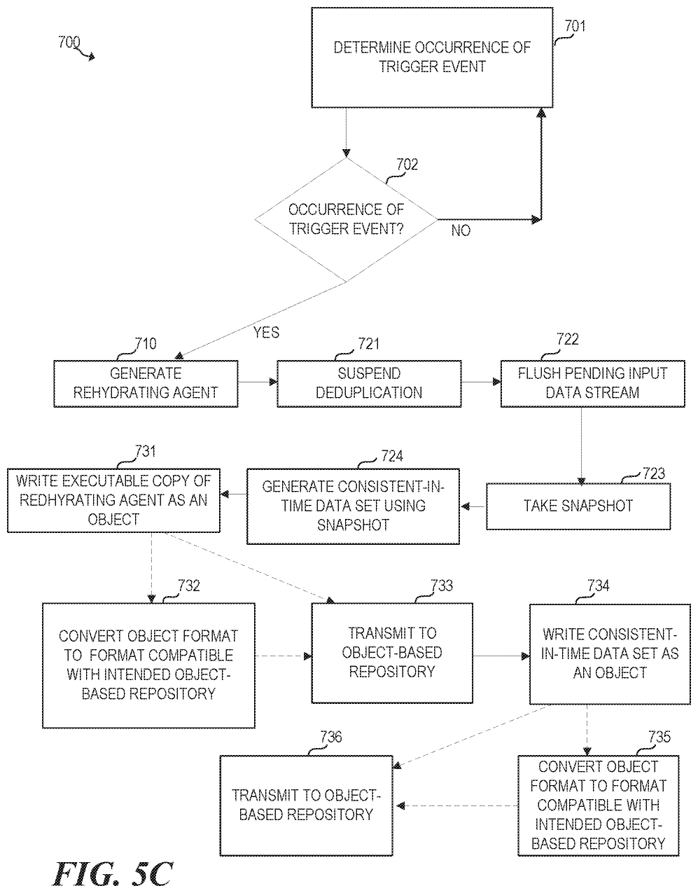

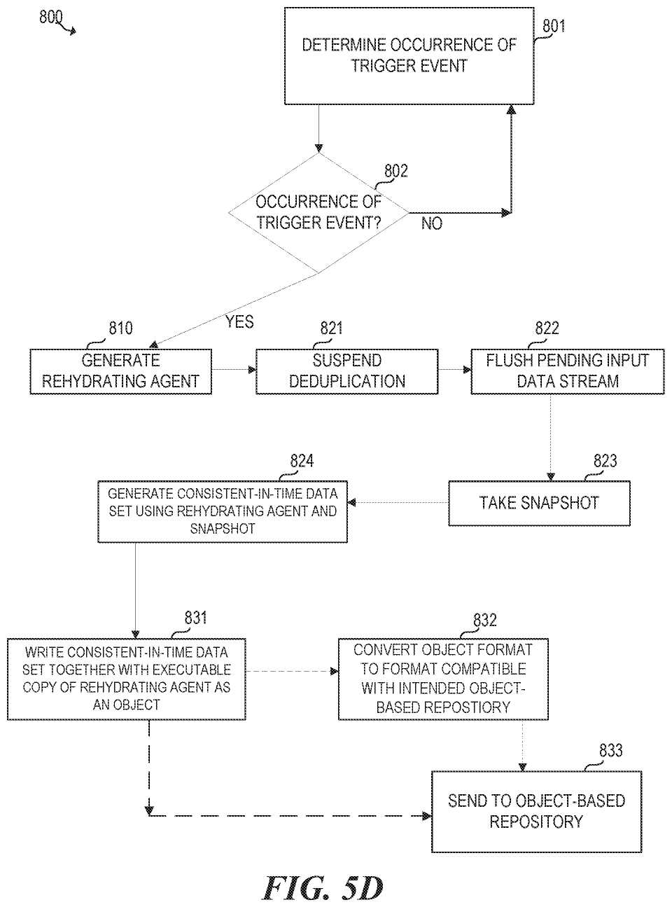

In the example of FIG. 1, instructions 111, 112, and 113 are stored (i.e. encoded) on storage medium 110 and are executable by processing resource 120 to implement functionalities described herein in relation to FIG. 1. In some examples, storage medium 110 may include additional instructions, for example, the instructions to implement some of the functionalities described herein in relation to FIG. 3 and FIGS. 5A-5D. In some examples, instructions 111-113 and any other instructions described herein in relation to storage medium 110 may be stored on a machine-readable storage medium remote from but accessible to computing device 100 and processing resource 120. In other examples, the functionalities of any of the instructions of storage medium 110 may be implemented in the form of electronic circuitry, in the form of executable instructions encoded on machine-readable storage medium, or a combination thereof.

Processing resource 120 may, for example, be in the form of a central processing unit (CPU), a semiconductor-based microprocessor, a digital signal processor (DSP) such as a digital image processing unit, other hardware devices or processing elements suitable to retrieve and execute instructions stored in a storage medium, or suitable combinations thereof. The processor can, for example, include single or multiple cores on a chip, multiple cores across multiple chips, multiple cores across multiple devices, or suitable combinations thereof. The processor can be functional to fetch, decode, and execute instructions 111, 112, and 113 as described herein.

In the example of FIG. 1, deduplicated data 131 is stored in a memory 130. Memory 130 may be separate from machine-readable storage medium 110 storing instructions 111-113 or may be implemented by machine-readable storage medium 110. In some examples, memory 130 comprises a secondary memory portion as discussed above. As used herein, “deduplicated data” includes data created from original input data (for example, data generated by a storage client) with at least some of duplicate data found in the original input data removed (for example, a majority of or all of duplicate data may be removed). Deduplicated data includes original input data that has been processed to remove duplicate data and original input data that exists in a buffer to be processed to remove duplicate data. Processing resource 120 is in communication with memory 130. While memory 130 is shown in the example of FIG. 1 as being housed in computing device 100, in other examples, memory 130 may be separate from computing device 100 but accessible to processing resource 120 of computing device 100. As will be discussed in relation to FIG. 3, in some examples, deduplicated data 131 may be associated with a deduplication engine.

Instructions 111 may be executable by processing resource 120 such that computing device 100 is operative to generate a consistent-in-time data set of deduplicated data 131. As used herein, “consistent-in-time data set of deduplicated data” is a copy of deduplicated data 131 that includes original input data that has been processed to remove duplicate data. The consistent-in-time data set does not include original input data that exists in a buffer to be processed. The portion of deduplicated data 131 that includes original input data in a buffer to be processed is flushed before it may be considered part of the consistent-in-time data set. In other words, the consistent-in-time data set is a copy of data that has been deduplicated as of one single point in time. In some examples, the consistent-in-time data set is used to ensure that there are no inconsistencies within the deduplicated data that is captured by the consistent-in-time data set. In some examples, instructions 111 may include suspending a deduplication process of a deduplication engine (see FIG. 3) to ensure that the pool of deduplicated data 131 does not change. In some examples, instructions 111 may include taking a snapshot of deduplicated data 131 and reading the snapshot to generate the consistent-in-time data set.

In some examples, the consistent-in-time data set of deduplicated data does not capture all of deduplicated data 131, but rather just a subset of deduplicated data 131. In these examples, instructions 111 may include instructions to determine an appropriate subset of deduplicated data 131 from which to generate the consistent-in-time data set. In some examples, these instructions may determine the appropriate subset of deduplicated data based (at least partially) on reference to a catalog that tracks the volumes of deduplicated data that have previously been sent to a storage medium. In some examples, these instructions may determine the appropriate subset of deduplicated data based (at least partially) on an age-rule of the age of the deduplicated data or a time-rule of how long it has been since the last archive. In some examples, these instructions may determine an appropriate subset of deduplicated data based (at least partially on) an input from a storage client selecting the specific data to archive. For example, the storage client may select a specific virtual cartridge or a specific file share or files within a file share to be archived. In some examples, a combination of at least one of these methods may be used to determine the appropriate subset.

The appropriate subset may include any other data that the subset is dependent on even though the other data would not be included in the subset on its own. The inclusion of this other data makes the subset independently coherent and consistent and free from reliance on external sources. For example, if the rule is to generate the subset from data generated during time period 3-4, the subset would include data generated during time period 3-4 but may also include data generated outside of time period 3-4 (e.g. during time period 1-2) if data generated in time 3-4 depends on the data generated outside of time period 3-4.

In some examples, the instructions 111 to generate the consistent-in-time data set may executed after a request for an archive is received. The request may be inputted by a user interfacing with a GUI on the storage client side (not shown).

Instructions 112 may be executable by processing resource 120 such that computing device 100 generates a rehydrating agent. As used herein, a “rehydrating agent” includes any mechanism, including suitable software application, appliance, virtual appliance, software agent, intelligent software agent, computer program, or the like that restores the consistent-in-time data set of deduplicated data to its original, duplicated (i.e. rehydrated or restored) form. Non-limiting examples of a rehydrating agent include a stand-alone executable file and a virtual appliance (including a virtual storage appliance (VSA) that runs on a virtual machine to consolidate the directly-attached storage capacity of different physical hosts to create a virtual storage pool). In this regard, a copy 132 of the rehydrating agent may be stored in memory 130 or in a remote memory that is in communication with processing resource 120. The portion of memory 130 where a copy 132 of rehydrating agent is stored may be non-volatile memory (e.g., secondary memory). In some examples, the generation of the rehydrating agent involves reading of copy 132 of the rehydrating agent from the non-volatile portion of memory 130. The rehydrating agent is then generated from the copy 132 of the rehydrating agent in the main memory (e.g., RAM).

The example of FIG. 1 includes instructions 113 executable by processing resource 120 to send the consistent-in-time data set to a storage resource 150. Additionally, instructions 113 are executable by processing resource 120 such that computing device sends an executable copy of the rehydrating agent to storage resource 150 from the generated rehydrating agent. The sending of the consistent-in-time data set and the executable copy of the rehydrating agent is represented in FIG. 1 by 140. Example transport protocols include any network based protocols such as fiber channel protocol (FCP), Ethernet, port control protocol (PCP), representational state transfer (REST), simple object access protocol (SOAP), etc., but are not limited to network based protocols.

As used herein, an “executable copy of the rehydrating agent” includes a copy of the generated rehydrating agent at a specific point in time. The executable copy allows the rehydrating agent to be generated as it existed when it was generated by instructions 112.

Storage resource 150 includes storage mediums and any storage service that relies on underlying storage mediums. Storage resource 150 may be different from machine-readable storage medium 110 and memory 130 in that storage resource 150 is not linked to the rehydrating agent. In some examples, storage resource 150 may include physical tapes, network attached storage (NAS), object-based data repositories functioning over a communications network (e.g. SWIFT, S3, etc.)). In some examples, storage resource 150 may be used in tertiary storage.

In some examples, computing device 100 may implement at least a portion of a data backup system. For example, instructions 111, 112, and 113 may be part of a larger set of instructions implementing functionalities of a backup system, and memory 130 may implement at least a portion of the storage of the backup system.

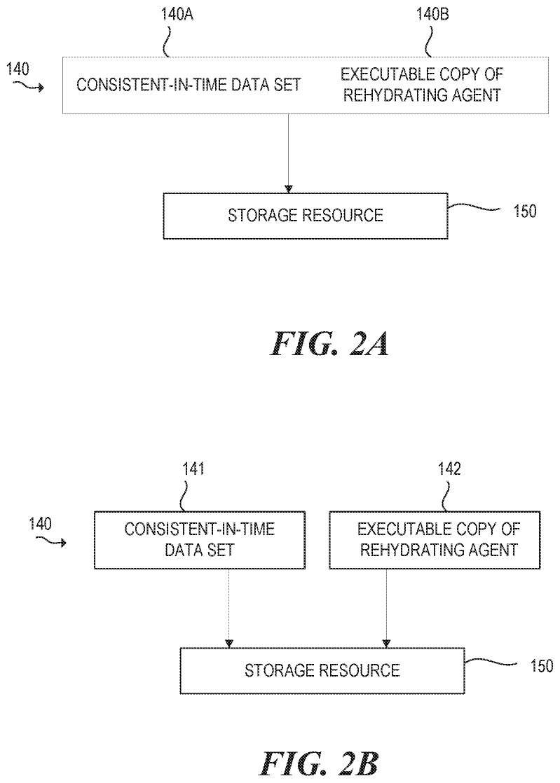

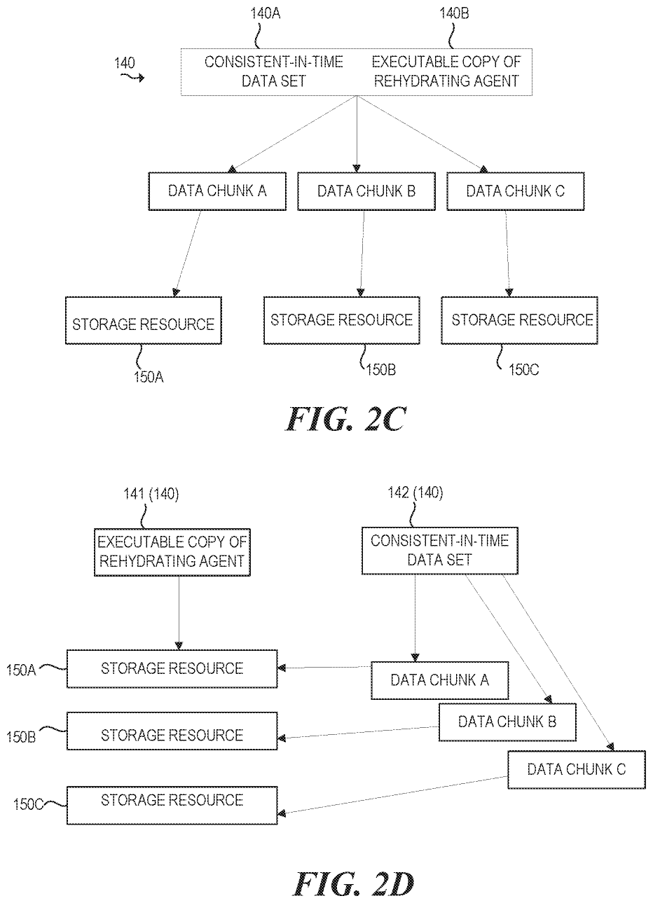

FIGS. 2A-2D illustrate diagrams of various ways that the consistent-in-time data set and the executable copy of the rehydrating agent may be sent to storage resource 150. In the example of FIG. 2A, data stream 140 from computing device 100 to storage resource 150 may include consistent-in-time data set 140A with executable copy of rehydrating agent 140B together at the same time. Thus, the consistent-in-time data set 140A is coupled to the executable copy of the rehydrating agent 140B. In some examples, this is because instructions 113 includes instructions to generate the consistent-in-time data set using the rehydrating agent that is generated from instructions 112. This allows the consistent-in-time data set 140A to be coupled with the executable copy of the rehydrating agent 140B. Some example methods of accomplishing this are described herein in relation to FIGS. 5B and 5D.

In the example of FIG. 2B, data stream 140 comprises at least two separate data streams. One data stream includes the consistent-in-time data set 141. Another data stream comprises the executable copy of rehydrating agent 142. These are sent to storage resource 150 separately and may be in different format from each other. Some example methods of accomplishing this are described herein in relation to FIGS. 5A and 5C.

In some examples, and as shown in FIGS. 2C and 2D, computing device 100 may send the consistent-in-time data set of deduplicated data and the executable copy of the rehydrating agent to multiple storage resources 150.

For example, in FIG. 2C, data stream 140 from computing device 100 to storage resource 150 may include consistent-in-time data set 140A and executable copy of the rehydrating agent 140B together at the same time. However, the space needed to store this data stream 140 exceeds the capacity of one storage resource 150A. Thus, the data stream 140 is broken up into different data chunks, data chunk A, data chunk B, and data chunk C, each to be stored on storage resource 150A, storage resource 150B, and storage resource 150C, respectfully. In some examples, data stream 140 may also include meta-data to act as a manifest. This manifest may be used to determine in what order to read the set of storage resource 150A, 150B, and 150C to fully regenerate the contents of data stream 140. In some examples, the meta-data may be written in an open format (e.g., extensible markup language (XML), etc.). In some examples, storage resources 150A, 150B, and 150C are the same type as one another (for example, all physical tapes).

In the example of FIG. 2D, data stream 140 from computing device 100 to storage resource 150 are separate data streams 141 and 142. Data stream 141 including the executable copy of the rehydrating agent may be sent to storage resource 150A. Consistent-in-time data set 142, however, may exceed the storage capacity of storage resource 150A. Thus, data stream 142 is broken into different data chunks: data chunk A, data chunk B, and data chunk C, each to be stored on storage resource 150A, storage resource 150B, and storage resource 150C. As described in reference to example FIG. 2C, data stream 140 may also include meta-data. This may be used in order to read the set of storage resource 150A, 150B, and 150C in the correct order to fully regenerate the contents of data streams 141 and 142.

As discussed above, the rehydrating agent may be a VSA. In some examples, the copy 132 of the rehydrating agent may be different between the examples of FIGS. 2A, 2C and the examples of FIGS. 2B, 2D. In the examples of FIGS. 2B and 2D, the copy of the VSA may be code executable to generate an appliance that runs and ingests data (e.g. obtain, import, and process data). In other words, the copy may generate an appliance with a fully functioning VSA, with capabilities other than rehydration capability (e.g. capabilities to manage the data after rehydration, etc.). In the examples of FIGS. 2A and 2C, the copy 132 of the rehydrating agent may be similar to but a smaller subset of the VSA discussed above. In some examples, it may not have the ability to ingest new data, but merely the ability the rehydrate the data. In other examples, however, the copy 132 of the rehydrating agent may be similar across the examples of FIGS. 2A, 2B, 2C, and 2D.

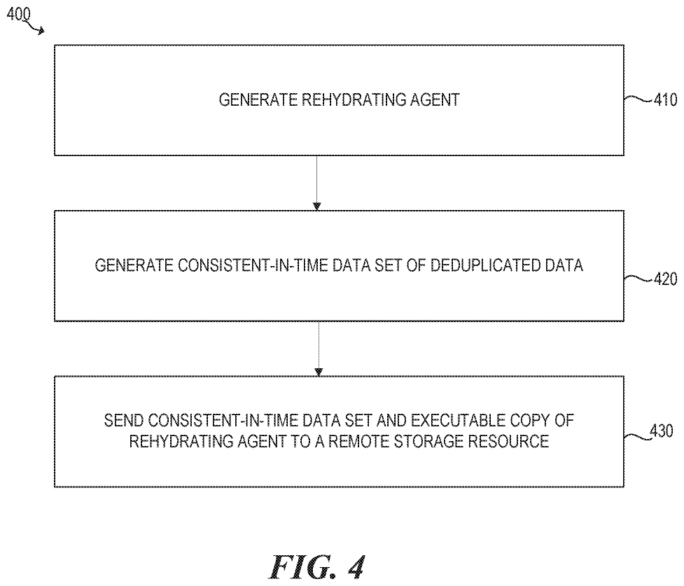

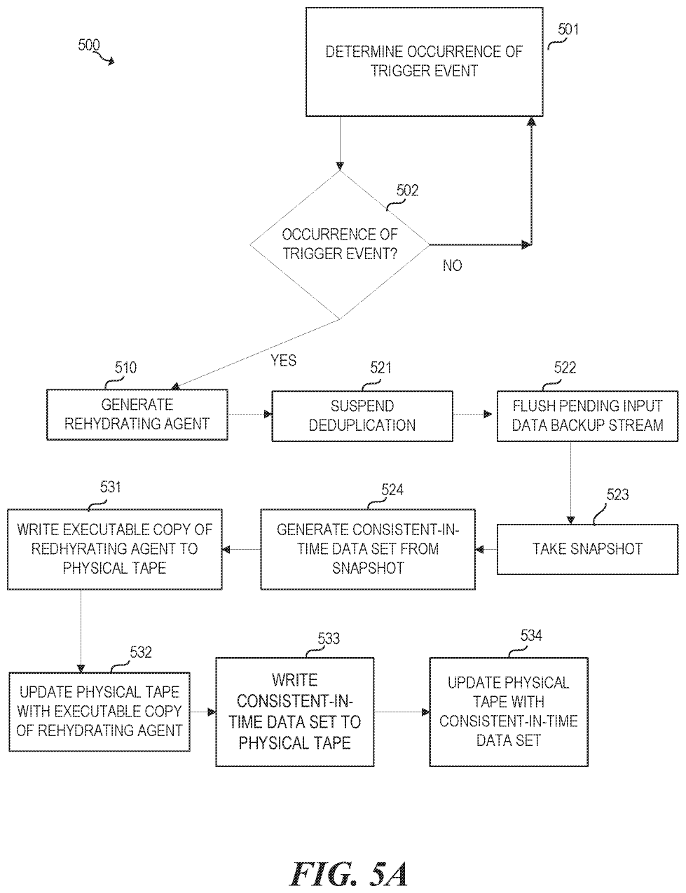

FIG. 4 illustrates a flowchart for a method 400 to send consistent-in-time data set and an executable copy of a rehydrating agent to a storage resource. Although execution of method 400 is described below with reference to computing device 100 of FIG. 1, other suitable systems for execution of method 400 can be utilized (e.g. system 300). Additionally, implementation of method 400 is not limited to such examples and it is appreciated that method 400 can be used for any suitable device or system described herein or otherwise.

At 410 of method 400, processing resource 120 may execute instructions 112 to generate a rehydrating agent from a copy 132 of the rehydrating agent in memory 130 of computing device 100. At 420 of method 400, processing resource 120 may execute instructions 111 to generate a consistent-in-time data set of deduplicated data 131 stored in memory 130. At 430 of method 400, processing resource 120 may execute instructions 113 to send the consistent-in-time data set and an executable copy of the rehydrating agent to a storage resource. In some examples, and in example method 400, the storage resource is remote from the deduplicated data 131. In some examples, a remote storage resource includes a storage resource that is different from the storage medium storing the deduplicated data. Different may include, among other things, a difference in physical location or a difference in type.

In some examples, at 430, instructions 113 may include instructions to send the consistent-in-time data set and the executable copy of the rehydrating agent to more than one storage resources of the same type, for example, spanning across more than one physical tape or object, as described above in relation to FIGS. 2C and 2D.

Although the flowchart of FIG. 4 shows a specific order of performance of certain functionalities, method 400 is not limited to that order. For example, some of the functionalities shown in succession in the flowchart may be performed in a different order, may be executed concurrently or with partial concurrence, or a combination thereof. In some examples, 420 may be start before 410 is completed. Additionally, although flowchart of FIG. 4 shows certain functionalities as occurring in one step, the functionalities of one step may be completed in at least one step (for example multiple steps). In some examples, at 430, instructions 113 may send the consistent-in-time data set together (i.e. coupled, in the same format) with the executable copy of the rehydrating agent, as described above in relation to FIGS. 2A and 2C. In other examples, at 430, instructions 113 may send the consistent-in-time data set separately (i.e. as two separate data streams) from the executable copy of the rehydrating agent, as described above in relation to FIGS. 2B and 2D.

FIG. 3 is a block diagram of an example system 300 to send consistent-in-time data set of deduplicated data and an executable copy of a rehydrating agent to a storage resource. The engines 301, 310, 320, 330, and 340 are operative to execute at least one computer instructions described herein.

Each of engines 301, 310, 320, 330, 340, and any other engines, may be any combination of hardware (e.g., a processor such as an integrated circuit or other circuitry) and software (e.g., machine or processor-executable instructions, commands, or code such as firmware, programming, or object code) to implement the functionalities of the respective engine. Such combinations of hardware and programming may be implemented in a number of different ways. A combination of hardware and software can include hardware only (i.e., a hardware element with no software elements), software hosted at hardware (e.g., software that is stored at a memory and executed or interpreted at a processor), or at hardware and software hosted at hardware. Additionally, as used herein, the singular forms “a,” “an,” and “the” include plural referents unless the context clearly dictates otherwise. Thus, for example, the term “engine” is intended to mean at least one engine or a combination of engines. In some examples, system 300 may include additional engines.

Each engine of system 300 can include at least one machine-readable storage mediums (for example, more than one) and at least one computer processors (for example, more than one). For example, software that provides the functionality of engines on system 300 can be stored on a memory of a computer to be executed by a processor of the computer. System 300 of FIG. 3, which is described in terms of functional engines containing hardware and software, can include one or more structural or functional aspects of computing device 100 of FIG. 1, which is described in terms of processors and machine-readable storage mediums.

In some examples, and as shown in FIG. 3, system 300 includes a deduplication engine 301, a policy engine 310, a data generation engine 320, an agent generation engine 330, and a transmit engine 340. Each of these aspects of system 300 will be described below. It is appreciated that other engines can be added to system 300 for additional or alternative functionality.

Deduplication engine 301 is an engine of system 300 that includes a combination of hardware and software that allows system 300 to generate deduplicated data. Deduplication engine 301 may organize the original input data into non-overlapping chunks by using a pointer at sites where duplicate data is found, rather than storing another copy (i.e. a duplicate) of the original data. In some examples, deduplication engine 301 may include hardware in the form of a microprocessor on a single integrated circuit, related firmware, or other software for allowing microprocessor to operatively communicate with other hardware of system 300. The discussion of deduplicated data 131 in relation to FIG. 1 above is applicable here.

Policy engine 310 is an engine of system 300 that includes a combination of hardware and software that allows system 300 to determine an occurrence of a trigger event. In some examples, a trigger event may include a storage client input signaling a request for an archive of deduplicated data. In some examples, a trigger event may include a determination that the deduplicated data has been stored in its deduplicated form for a specific time period. For example, a storage client may specify through a user interface that deduplicated data should be archived every 30 days. Thus, in those examples, a trigger event would include the passage of 30 days. In some examples, a trigger event may include a determination that the deduplicated data is of a specific type of data or from a specific origin.

In some examples, and as in the example of FIG. 3, policy engine 310 initializes data generation engine 320 and agent generation engine 330. This is represented by connection line 315 in FIG. 3. In some examples, policy engine may also send a query (i.e. request for information) to the storage resource to determine a storage space availability on the storage resource. Thus, in some examples, policy engine 310 may include hardware in the form of a microprocessor on a single integrated circuit, related firmware, or other software for allowing microprocessor to operatively communicate with other hardware of system 300.

Data generation engine 320 is a functional engine of system 300 that includes a combination of hardware and software that allows system 300 to generate consistent-in-time data set of a store of deduplicated data present on system 300 or accessible to system 300 in response to an input from policy engine 310 that a trigger event has occurred. The discussion of consistent-in-time data set in relation to instructions 111 of computing device 100 is applicable to the consistent-in-time data set of data generation engine 320.

In some examples, data generation engine 320 allows system 300 to generate consistent-in-time data set of a subset of the deduplicated data that has been generated by deduplication engine 301. In some examples, the appropriate subset of deduplicated data may be determined based (at least partially on) the boundaries of the trigger event discussed above in relation to policy engine 310. For example, if the rule in operation in policy engine 310 is that an archive is generated every 30 days, data generation engine 320 may generate different consistent-in-time data sets at day 30 and at day 60. For day 30, data generation engine 320 may generate a consistent-in-time data set of the entirety of deduplicated data, assuming that day 0 was the first day of deduplication. For day 60, however, data generation engine 320 may generate a consistent-in-time data set of a portion of deduplicated data, specifically from day 31 to day 60. The discussion of a subset of the deduplicated data in relation to instructions 111 of computing device 100 is applicable here.

In some examples, and as in the example of FIG. 3, data generation engine 320 interfaces with deduplication engine 301 to generate the consistent-in-time data set. This is represented by connection line 305 in FIG. 3. When data generation engine 320 is initialized by policy engine 310, data generation engine 320 operatively communicates with deduplication engine 301 to suspend the deduplication process of deduplication engine 301. Data generation engine 320 also operatively commands deduplication engine 301 to flush all pending input data stream. In some examples, and as will be discussed in relation to FIGS. 5A-5D, data generation engine 320 takes a snapshot of deduplication engine 301 and the deduplicated data stores associated with the deduplication engine 301.

Agent generation engine 330 is a functional engine of system 300 that includes a combination of hardware and software that allows system 300 to generate a rehydrating agent. In some examples, this includes reading a copy of the rehydrating agent stored in secondary memory (e.g. hard disk), as described in relation to 132 in FIG. 1, and executing the copy in main memory (e.g. RAM). Thus, in some examples, agent generation engine 330 may include hardware in the form of a microprocessor on a single integrated circuit, related firmware, or other software for allowing microprocessor to operatively communicate with other hardware of system 300.

Transmit engine 340 is a functional engine of system 300 that includes a combination of hardware and software that allows system 300 to transmit the consistent-in-time data set generated by data generation engine 320 and an executable copy of the rehydrating agent to a storage resource. The interface of transmit engine 340 with agent generation engine 330 and data generation engine 320 is represented by line 325 in FIG. 3. In some examples, transmit engine 340 provides functionalities related to 531, 532, 533, and 534 of method 500 described below. In other examples, transmit engine 340 provides the functionalities related to 631 and 632 of method 600 as described below. In yet other examples, transmit engine 340 provides the functionalities related to 731, 732, 733, 734, 735, and 736 of method 700 as described below. In yet additional examples, transmit engine 340 provides the functionalities related to 831, 832, and 833 of method 800 as described below.

In some examples, transmit engine 340 may send the consistent-in-time data set and the executable copy of the rehydrating agent to a physical tape (see FIGS. 5A and 5B). Examples of transport protocols are similar to those described above in relation to instructions 113. In these examples, transmit engine 340 may include a drive head with multiple read and write elements for reading or writing a plurality of tracks on the physical tape. In some examples, transmit engine 340 may also include a drive reel to accept the physical tape. During operation, transmit engine 340 spools the physical tape around the drive reel while being passed across the drive head to update the physical tape. In some examples, transmit engine 340 may include hardware in the form of a microprocessor on a single integrated circuit, related firmware, or other software for allowing microprocessor to operatively communicate with other hardware of system 300.

In some examples, transmit engine 340 may send the consistent-in-time data set and the executable copy of the rehydrating agent to an object-based repository. In an object structure, each object may include the underlying data, some metadata, and a globally unique identifier. In those examples, transmit engine 340 may provide system 300 with the functionality of writing the consistent-in-time data set and the executable copy of the rehydrating agent as an object. The object exists in transient (primary) memory until it is sent to the repository. Additionally, transmit engine 340 may include a data connector engine. Data connector engine is a functional engine of system 300 that includes a combination of hardware and software that allows system 300 to convert an object from one object format to another object format. Data connector engine may be present when the storage medium being used is an object-based repository, like in the example methods of FIGS. 5C and 5D. In some examples data connector engine may be an Application Programmable Interface (API) that allows connectivity to the object-based repository.

FIG. 5A illustrates a flowchart for a method 500 to send consistent-in-time data set and an executable copy of a rehydrating agent to a physical tape drive. Although execution of method 500 is described below with reference to system 300 of FIG. 3, other suitable systems for execution of method 500 can be utilized (e.g. computing device 100). Additionally, implementation of method 500 is not limited to such examples and it is appreciated that method 500 can be used for any suitable device or system described herein or otherwise.

At 501 of method 500, policy engine 310 of system 300 may determine the occurrence of a trigger event. The discussion above of a trigger event in relation to policy engine 310 is also applicable at 501. At 502, method 500 proceeds to 510 if there is a determination that a trigger event has occurred. In some examples, policy engine 310 may determine that a trigger event has occurred if it receives an input for a request for an archive, as discussed in relation to policy engine 310 above. If there is no determination that a trigger event has occurred, method 500 iterates back to 501 to determine an occurrence of a trigger event. At 510 of method 500, agent generation engine 330 generates a rehydrating agent. 510 of method 500 is similar to 410 of method 400 and the discussion above in relation to 410 is applicable here.

At 521, data generation engine 320 suspends a deduplication process of deduplication engine 301 of system 300. This suspension may be characterized as a quiescence operation of the deduplication engine 300. At 522, data generation engine 320 instructs deduplication engine 301 of system 300 to flush any input backup data stream pending in a buffer storage of deduplication engine 301. At 523, data generation engine 320 takes a snapshot of deduplication engine 301 and any associated data stores of deduplication engine 301, including deduplicated data stores, indices, meta-data, log files, OS files, etc. This snapshot generation at 523 allows deduplication engine 301 to resume its deduplication process, as data generation engine 320 may create the consistent-in-time data set from the snapshot.

At 524 of method 500, data generation engine 320 generates a consistent-in-time data set from the snapshot generated at 523. In some examples, the consistent-in-time data set is generated by reading the snapshot, allowing data generation engine 320 to create a data drive containing the deduplicated data as well as the indices, meta-data, log files, etc. In some examples, method 500 may not include 523 of taking a snapshot. Instead, method 500 may skip 523 and go to 524. In these examples, the consistent-in-time data set is not generated from reading the snapshot, but from copying the deduplicated data from the memory associated with deduplication engine 301.

At 531 of method 500, transmit engine 340 may write an executable copy of the rehydrating agent generated at 510 by agent generation engine 330 to a physical tape. At 532, method 500 updates (i.e. commits) the executable copy of the rehydrating agent to the physical tape. In some examples, transmit engine 340 may control physical tapes and be an interface between the physical tapes and the other engines of system 300. Transmit engine 300 may write and commit (i.e. update) the executable copy of the rehydrating agent to the physical tape, as described above in relation to FIG. 3.

At 533, transmit engine 340 may write the consistent-in-time data set generated by data generation engine 320 at 521-524 to a physical tape. At 534, transmit engine may update the physical tape with the consistent-in-time data set. In some examples, transmit engine may commit the write of the consistent-in-time data set and the executable copy of rehydrating agent over more than one physical tape, as discussed in relation to FIG. 2D. In the method example of FIG. 5A, the executable copy of the rehydrating agent and the consistent-in-time data set are stored as separate files on the physical tape, as discussed above in relation to FIGS. 2B and 2D.

Although the flowchart of FIG. 5A shows a specific order of performance of certain functionalities, method 500 is not limited to that order. For example, some of the functionalities shown in succession in the flowchart may be performed in a different order, may be executed concurrently or with partial concurrence, or a combination thereof, unless the context is contrary to that interpretation (for example, with respect to 501 and 502). In some examples, 521 may be start before 510 is completed. In other examples, 510 may start after 521-524. In some examples, 533-534 may start before 531-532.

FIG. 5B illustrates a flowchart for a method 600 to send consistent-in-time data set together with an executable copy of a rehydrating agent to a physical tape. Although execution of method 600 is described below with reference to system 300 of FIG. 3, other suitable systems for execution of method 600 can be utilized (e.g. computing device 100). Additionally, implementation of method 600 is not limited to such examples and it is appreciated that method 600 can be used for any suitable device or system described herein or otherwise.

At 601, policy engine 310 determines an occurrence of a trigger event. This determination may be performed as described above in relation to 501 of method 500. At 602, policy engine 310 may trigger agent generation engine 330 to generate a rehydrating agent if policy engine 310 has determined that a trigger event has occurred. This may be performed as described above in relation to 502 of method 500. At 610, agent generation engine 330 of system 300 may generate a rehydrating agent. This may be performed as described above in relation to 510 of method 500.

At 621, 622, and 623, data generation engine 320 suspends a deduplication process of deduplication engine 301, flushes any pending input data stream, and takes a snapshot. 621, 622, and 623 may be performed as described above in relation to 521, 522, and 523 of method 500.

At 624, data generation engine 320 of system 300 generates a consistent-in-time data set from the snapshot generated at 623 using the rehydrating agent generated by agent generation engine 330. In some examples, this includes a reading of the snapshot and a writing of the consistent-in-time data with the rehydrating agent. What is generated from this is a consistent-in-time data set of the deduplicated data coupled to an executable copy of the rehydrating agent. In other words, the executable copy of the rehydrating agent contains with it the consistent-in-time data set of the deduplicated data. In some examples, the executable copy of the rehydrating agent may be an image of a virtual storage appliance (i.e. a copy of an appliance at a specific point in time). In this regard, the executable copy of the rehydrating agent may be thought of as carrier allowing rehydration of the data coupled to the carrier and the consistent-in-time data set may be thought of the data.

At 631 of method 600, transmit engine 340 writes the consistent-in-time data set with the executable copy of the rehydrating agent generated in 624 to a physical tape. This is performed as described above in relation to 531 in method 500, the difference here being that 631 includes the consistent-in-time data set with the executable copy of the rehydrating agent. At 632 of method 600, transmit engine 340 updates the physical tape with the consistent-in-time data set and the executable copy of the rehydrating agent. This is performed as described above in relation to 532 of method 500, the difference here being that the update includes both the consistent-in-time data set and the executable copy of the rehydrating agent.

Although the flowchart of FIG. 5B shows a specific order of performance of certain functionalities, method 600 is not limited to that order. For example, some of the functionalities shown in succession in the flowchart may be performed in a different order, may be executed concurrently or with partial concurrence, or a combination thereof, unless the context of the functionality is contrary to the rearrangement (for example, with respect to 601, 602, 610, and 624). In some examples, 621-623 may be completed before 610 is completed.

FIG. 5C illustrates a flowchart for a method 700 to send consistent-in-time data set and an executable copy of a rehydrating agent to an object-based repository. Although execution of method 700 is described below with reference to system 300 of FIG. 3, other suitable systems for execution of method 700 can be utilized (e.g. computing device 100). Additionally, implementation of method 700 is not limited to such examples and it is appreciated that method 700 can be used for any suitable device or system described herein or otherwise.

701 and 702 of method 700 are similar to 601, 602 of method 600 and 501, 502 of method 500 and are performed in accordance with the descriptions above. Additionally, the discussion above in relation to 610, 510; 621, 521; 622, 522; 623, 523; and 524 is applicable to 710, 721, 722, 723, and 724, respectively. At 731 of method 700, an executable copy of the rehydrating agent that is generated at 710 is written by transmit engine 340. As discussed above in relation to FIG. 3, transmit engine 340 may write the executable copy of the rehydrating agent in an object format.

Because there are various types of object-based repositories (for example, SWIFT OpenSource, S3, etc.) with different formats, transmit engine 340 of system 300 may convert, at 732, the object written in 731 to a format that is compatible with the intended object-based repository. At 733 of method 700, transmit engine 340 transmits the object containing the executable copy of the rehydrating agent to the object-based repository. Transport protocol may include Hypertext Transfer Protocol (HTTP), SOAP, REST, etc. In some examples, if the object write in 731 is compatible with the intended object-based repository, transmit engine 340 skips 732 and goes directly to 733. The dashed lines in FIG. 5C connecting 731,732, and 733 shows two possible paths of progression from 731 to 733.

At 734, transmit engine 340 writes the consistent-in-time data generated in 724 as an object. At 735, transmit engine 340 of system 300 may convert the object written in 734 to a format that is compatible with the intended object-based repository. At 736 of method 700, transmit engine 340 transmits the object containing the executable copy of the rehydrating agent to the object-based repository. In some examples, if the object write in 734 is compatible with the intended object-based repository, transmit engine 340 skips 735 and goes directly to 736. The dashed lines in FIG. 5C connecting 734, 735, and 736 shows two possible paths of progression from 734 to 736.

Although the flowchart of FIG. 5C shows a specific order of performance of certain functionalities, method 700 is not limited to that order. For example, some of the functionalities shown in succession in the flowchart may be performed in a different order, may be executed concurrently or with partial concurrence, or a combination thereof, unless the context of the function is contrary to that interpretation (for example, with respect to 701 and 702). In some examples, 721 may be start before 710 is completed. In other examples, 710 may start after 721-724. In some examples, 731-734 may start before 731-733.

FIG. 5D illustrates a flowchart for a method 800 to send consistent-in-time data set and an executable copy of a rehydrating agent to an object-based repository. Although execution of method 800 is described below with reference to system 300 of FIG. 3, other suitable systems for execution of method 800 can be utilized (e.g. computing device 100). Additionally, implementation of method 800 is not limited to such examples and it is appreciated that method 800 can be used for any suitable device or system described herein or otherwise.

801 and 802 of method 800 are similar to 501, 502 of method 500; 601, 602 of method 600; and 701, 702 of method 700. Additionally, the discussion above in relation to 710, 610, 510; 721, 621, 521; 722, 622, 522; and 723, 623, 523 is applicable to 810, 821, 822, and 823, respectively.

At 824 of method 800, data generation engine 320 generates consistent-in-time data set using the rehydrating agent and the snapshot. This is generated as described above in relation to 624 of FIG. 5B. At 831, transmit engine 340 writes an object containing the consistent-in-time data set and the executable copy of the rehydrating agent. This is done as described above in relation to 631 of FIG. 5B. At 832, transmit engine 340 of system 300 may convert the object written in 831 to a format that is compatible with the intended object-based repository. At 833 of method 800, transmit engine 340 transmits the object containing the consistent-in-time data and the executable copy of the rehydrating agent to the object-based repository. In some examples, if the write in 831 is compatible with the intended object-based repository, transmit engine 340 skips 832 and goes directly to 833. The dashed lines in FIG. 5D connecting 831, 832, and 833 shows two possible paths of progression from 831 to 833.

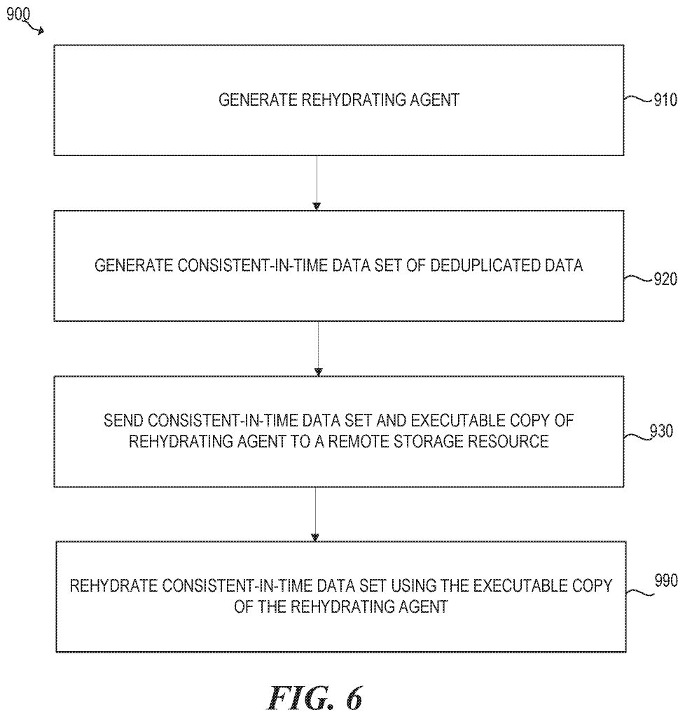

FIG. 6 illustrates a flowchart for a method 900 to send consistent-in-time data set and an executable copy of a rehydrating agent to an object-based repository, according to some examples. Method 900 of FIG. 6 is similar to method 400 of FIG. 4 except that method 900 includes 990. At 990 of method 900, a storage server or another computer that is different from computing device 100 may rehydrate or restore the consistent-in-time data set using the executable copy of the rehydrating agent. In some examples, the computer that rehydrates the consistent-in-time data set may not have a copy of the rehydrating agent. Although execution of method 900 is described below with reference to another computer or storage server other than computing device 100, computing device 100 or system 300 may also be used.

In examples where the executable copy of the rehydrating agent is sent together with the consistent-in-time data set to the storage resource, (see FIGS. 2A, 2C, 5B, and 5D), to rehydrate, the storage resources containing the executable copy of the rehydrating agent and the consistent-in-time data set are read. In order to read information from the storage resource, the storage server or another computer can first consult a catalog database to determine which storage resource contains the information.

In examples where the storage resource is a physical tape, the storage server or another computer can instruct a robotic arm to fetch the tape and place it in a drive, or other reader mechanism. In examples where the storage resource is an object-based repository, the object can be read or recalled through an appropriate command (for example, HTTP GET over SWIFT RESTFul API).

The reading of the storage resource generates a rehydrating agent from the executable copy of the rehydrating agent. Because the consistent-in-time data set of deduplicated data is coupled with the executable copy of the rehydrating agent, the read rehydrates (or restores) the entirety of the consistent-in-time data set of deduplicated data. In this regard, it is envisioned that the restoration process of the consistent-in-time data set includes sending a command to an associated storage server to identify a requirement for the raw storage medium capacity of the deduplicated data, provisioning and portioning the needed logical unit numbers (LUN), and restoring the deduplicated data to the identified storage medium. In these examples, the deduplicated data that is rehydrated is the deduplicated data that was captured by the consistent-in-time data set. For example, the rehydrating agent may be a virtual storage appliance, that when opened, automatically rehydrates and writes the data to disk arrays, allowing the storage client access to the rehydrated data that came from the consistent-in-time data set.

In examples where the executable copy of the rehydrating agent is sent separate from the consistent-in-time data set (see FIGS. 2B, 2D, 5A, SC), to rehydrate, a read of the backup resources generates a rehydrating agent from the executable copy of the rehydrating agent. Because the consistent-in-time data set is not coupled with the executable copy of the rehydrating agent, the rehydrating agent does not restore the consistent-in-time data set upon its execution. Instead, the rehydrating agent that is generated may be used to restore the consistent-in-time data set of deduplicated data. In this regard, a storage client may pick and choose certain portions of the deduplicated data present in the consistent-in-time data set to restore as needed. In some examples, methods 400, 500, 600, 700, and 800 may include rehydrating the consistent-in-time data set of deduplicated data using the executable copy of the rehydrating agent. This may be done after 430 of method 400, after 534 of method 500, after 736 of method 700, and after 833 of method 800.

All of the features disclosed in this specification (including any accompanying claims, abstract and drawings), and/or all of the elements of any method or process so disclosed, may be combined in any combination, except combinations where at least some of such features and/or elements are mutually exclusive.

What is claimed is:

1. An article comprising at least one non-transitory machine-readable storage medium comprising instructions executable by a processing resource of a computing device to:
generate a rehydrating agent;
generate a consistent-in-time data set of deduplicated data; and
send the consistent-in-time data set and an executable copy of the rehydrating agent to a storage resource.

2. The article of claim 1, wherein the generation of the consistent-in-time data set is in response to a request for an archive of the deduplicated data.

3. The article of claim 1, wherein the instructions to send the consistent-in-time data set and the executable copy of the rehydrating agent to the storage resource comprise instructions to send the consistent-in-time data set with the executable copy of the rehydrating agent.

4. The article of claim 3, wherein the instructions to generate the consistent-in-time data set comprise instructions to generate the consistent-in-time data set using the rehydrating agent.

5. The article of claim 1, wherein the instructions to send the consistent-in-time data set and the executable copy of the rehydrating agent to the storage resource comprise instructions to send the consistent-in-time data set separate from the executable copy of the rehydrating agent.

6. The article of claim 1, wherein the rehydrating agent comprises a virtual storage appliance.

7. A system comprising:
a deduplication engine to generate deduplicated data;
a policy engine to determine an occurrence of a trigger event;
a data generation engine, in response to the determination of an occurrence of the trigger event, to generate a consistent-in-time data set of the deduplicated data;
an agent generation engine, in response to the determination of an occurrence of the trigger event, to generate an executable copy of a rehydrating agent; and
a transmit engine to send the consistent-in-time data set and an executable copy of the rehydrating agent to a storage resource.

8. The system of claim 7, wherein the consistent-in-time data set represents a subset of the deduplicated data, and the data generation engine is to determine the subset of deduplicated data.

9. The system of claim 7, wherein the storage resource is an object-based data repository, and the transmit engine comprises a data connector engine to convert a format of the consistent-in-time data set and the executable copy of the rehydrating agent to a format compatible with the object-based data repository.

10. The system of claim 7, wherein the storage resource is a physical tape, and the transmit engine is to update the physical tape with the consistent-in-time data set and the executable copy.

11. The system of claim 7, wherein policy engine is to determine a storage availability of the storage resource.

12. A method comprising:
generating a consistent-in-time data set of deduplicated data;
generating a rehydrating agent; and
sending the consistent-in-time data set and an executable copy of the rehydrating agent to a remote storage resource.

13. The method of claim 12, wherein the remote storage resource is a physical tape.

14. The method of claim 12, wherein the remote storage resource is an object-based data repository.

15. The method of claim 12, comprising rehydrating the consistent-in-time data set using the executable copy of the rehydrating agent.
